(19) United States
(12) Patent Application Publication
(10) Pub. No.: US 2025/0229711 A1
(43) Pub. Date: Jul. 17, 2025

(54) VARIABLE AUDIO SIGNALING DEVICE FOR A VEHICLE

(71) Applicant: Accel Corp LLC, Pawleys Island, SC (US)

(72) Inventor: Jim Hannon, Pawleys Island, SC (US)

(73) Assignee: Accel Corp LLC, Pawleys Island, SC (US)

(21) Appl. No.: 18/950,101

(22) Filed: Nov. 17, 2024

Related U.S. Application Data
(60) Provisional application No. 63/621,685, filed on Jan. 17, 2024.

(51) Int. Cl. B60Q 5/00; G10K 9/12

(52) U.S. Cl. CPC B60Q 5/003; G10K 9/12

(57) ABSTRACT

A variable audio signaling device for a vehicle comprising: a controller adapted to be integrated into an existing horn circuitry without the need for additional switches and isolate a second horn from a first horn so that when a switch is actuated, the first horn is actuated; and, wherein the controller is adapted to receive the switch actuation, wait a predetermined period of time and actuate the second horn. The system can include a controller adapted to be integrated into an existing horn circuitry without the need for additional switches and isolate a first horn and a second horn; and, wherein the controller is adapted to receive the switch actuation, actuate the first horn, wait a predetermined period and actuate the second horn. The controller can be adapted to increase the volume of the first horn after a length of time.

### RELATED APPLICATIONS

This application claims priority from U.S. Provisional Patent Application 63/621,685 filed Jan. 17, 2024 incorporated by reference.

### BACKGROUND

### 1) Field of the Invention

The present invention relates to a system and computerized method for controlling the output of an audio signaling device of a vehicle such as a horn, and more particularly for varying the output of the audio signaling system according to the input received from the vehicle operator and the vehicle controls.

### 2) Description of the Related Art

A vehicle horn is an electromechanical device used to produce a loud sound as a signal to other drivers, pedestrians, or animals. It is typically activated by pressing a button or pad on the steering wheel. When the horn is actuated, it closes an electrical circuit, allowing current to flow to the horn. At this point, an electromagnet moves a diaphragm back and forth at a high speed, creating sound waves. The sound waves passes through a trumpet or similar component to amplify it, giving it the distinctive “honking” sound. Horns are designed to produce a specific pitch and volume that can be heard over surrounding noise, making them an effective warning signal.

A vehicle horn has certain audio properties that are designed to be attention-grabbing, penetrating, and recognizable. To achieve these goals, the horn can have specific audio characteristics that include a typical operating frequency between 300 Hz and 4,000 Hz. Many horns use a dual tone with frequencies around 400 Hz and 500 Hz to create a harmonious yet piercing sound. The horn can be designed to be loud enough to be heard over ambient noise such as traffic noise and is typically between 100 to 110 decibels (dB) at a distance of about 2 meters. Truck and emergency vehicle horns can be even louder.

Drivers use horns in vehicles primarily as a safety tool to communicate with other road users. Horns signal to other drivers of your presence, especially in blind spots or crowded areas. If another driver or pedestrian isn't paying attention, a horn can help avoid a collision by drawing their focus back to the road. In case of emergencies, a horn can indicate that a driver needs to pass through quickly or to clear the way. A horn can warn others of an immediate hazard, such as an approaching vehicle in poor visibility. While essential for safety, proper horn usage is important to avoid unnecessary noise pollution, especially in crowded or residential areas. In this regard, a horn with one or limited audio properties is not appropriate for each situation.

Not all situations need the typical loud horn. For example, in a parking lot or at low speeds, a quieter horn could effectively alert nearby pedestrians or drivers without being overly jarring. In quiet, residential zones, a softer horn would reduce noise pollution and still signal other drivers or pedestrians, especially during early morning, late-night hours and in quite zones such as hospitals and nursing homes. In quiet, residential zones, a softer horn would reduce noise pollution and still signal other drivers or pedestrians, especially during early morning or late-night hours. When cars navigate through areas with high foot traffic, especially where speeds are low, a softer horn can be more appropriate to avoid startling pedestrians. When maneuvering in confined spaces, such as garages, a lower-volume horn could effectively warn others without causing unnecessary disruption in the echo-prone environment.

Further, vehicle horns usually emit a nearly square waveform, which is sharp and abrupt. This type of waveform enhances audibility in noisy environments but can cause a jarring response and contribute to unnecessary noise pollution. A horn's sound also has a quick “attack” time, meaning it reaches full volume almost instantly when pressed, to ensure immediate attention. The tone quality of a car horn is harsh and brassy because it is designed for abrupt signaling clarity rather than providing a polite warning. These properties are standardized to ensure that car horns are universally recognizable and effective across diverse traffic environments. However, they are not for all situations.

Desired notifications to pedestrians and third parties can arise in different situations from wanting to provide a friendly attention getting output to providing an immediate danger output. The former can be desired to be a high-pitched short burst while the latter has a lower pitched and longer output. Generally, the horn is activated to warn others of the vehicle's presence or approach, or to call attention to some hazard. However, in some cultures the use of the horn for a vehicle is simply a communication that the originating vehicle is in proximity of the receiving drivers, for example, when lanes of traffic are not as clear. On observer stated that use of the horn in some cultures is simply indicating that the approaching vehicle is “on the left or “on the right” as in the snowing skiing culture. In this case, the lower tone, longer, louder horn is not desirable and can improperly communicate impatience, danger, and the like. It would be desirable to have the ability to have a vehicle audio system to include variable output corresponding to the circumstances.

There has been some attempts to provide modify the horn sound output, but such attempts include specialized equipment that is not readily retrofit to existing vehicles and limited in application. For example, U.S. Pat. No. 9,452,711 discloses a horn sound output control apparatus of a vehicle, including a vehicle speed comparing unit; an object determining unit which, when it is determined that the current speed of the principle vehicle is equal to or lower than the reference speed, it determines that an object located within a predetermined distance from the principle vehicle is the other vehicle; a horn volume adjusting unit which, when it is determined that the object is the other vehicle, adjusts a horn volume of the principle vehicle to maintain a reference volume and when it is determined that the object is not the other vehicle, adjusts the horn volume of the principle vehicle to be equal to or lower than the reference volume; and a horn sound output unit which outputs a horn sound of the principle vehicle to the outside based on the adjusted horn volume. Such attempts do not allow the vehicle operator to use the operator's judgment in the output of the audio system.

It would be advantageous to have a horn with variable audio properties that can be actuated based upon the circumstances in which the horn is being used.

It would also be advantageous to have a horn with variable audio properties that can be controlled by the typical horn actuator.

### BRIEF SUMMARY OF THE INVENTION

The above objectives are accomplished by providing a variable audio signaling device for a vehicle comprising: a controller adapted to be integrated into an existing horn circuitry without the need for additional switches and isolate a second horn from a first horn so that when a switch is actuated, the first horn is actuated; and, wherein the controller is adapted to receive the switch actuation, wait a predetermined period of time and actuate the second horn. The system can include a controller adapted to be integrated into an existing horn circuitry without the need for additional switches and isolate a first horn and a second horn; and, wherein the controller is adapted to receive the switch actuation, actuate the first horn, wait a predetermined period and actuate the second horn. The controller can be adapted to increase the volume of the first horn after a length of time.

### BRIEF DESCRIPTION OF SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1A is a schematic of aspects of the present system.

FIG. 1B is a schematic of aspects of the present system.

FIG. 2 is a schematic of aspects of the present system.

FIG. 3 is a flowchart of aspects of the present system.

FIG. 4 is an illustration of aspects of the present system.

FIG. 5 is an illustration of aspects of the present system.

### DETAILED DESCRIPTION OF THE INVENTION

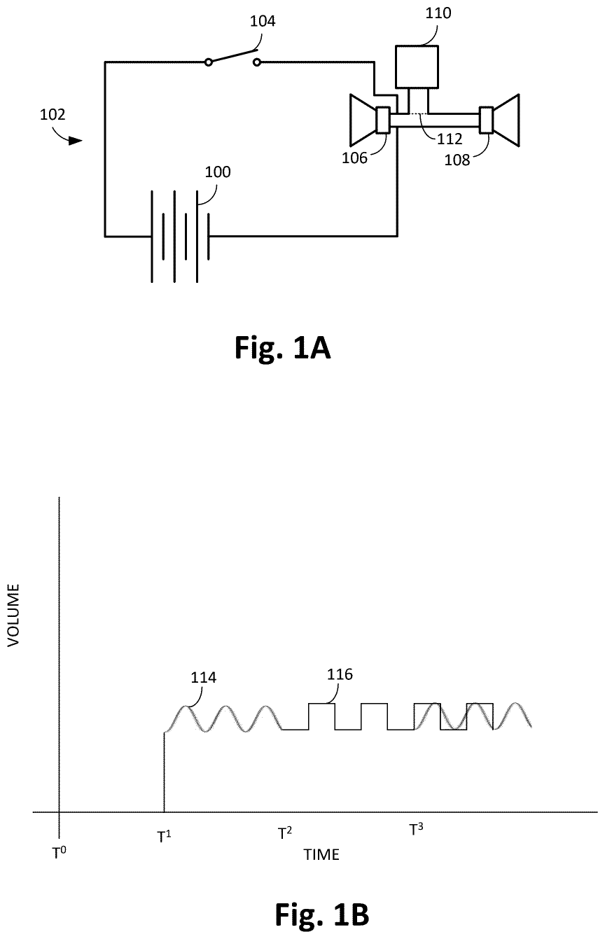

With reference to the drawings, the invention will now be described in more detail. The audio modification system is designed to retrofit an existing vehicle with little medication to the factory circuits. The power supply can be the vehicle battery, which can be used for the electrical system in fossil fuel vehicles, main power for electrical vehicles or the power system for hybrids. Referring to FIG. 1A, power supply 100 can be in a circuit shown generally as 102. The circuit can include a switch 104 such as one located at the center of a steering wheel and actuated by pressure on the center of the steering wheel. A first horn 106 having a first tone can be included in the circuit and a second horn 108 having a second tone can be included in the circuit. The first horn can include a higher pitch than the second horn. The first horn can include lower volume than the second horn. In one embodiment, controller 110 is inserted into the circuit by separating connection 112 and attaching the controller to each side of the separation. In one embodiment, the controller can include circuitry that can have a resistor (R) and capacitor (C) that can be selected to determine the delay. In one embodiment, when power is provided to the controller, the power can be oscillated to C so that C is charged when the power is high and is not fully charged until sufficient highs are reached allowing the delay.

In one embodiment the controller can be an integrated circuit with components present on a circuit board. In one embodiment, the components can be software implemented using gates on a circuit board. In one embodiment, the controller can also include computer readable instructions (e.g., read-only memory) that allow for a delay between the time power is provided to the controller and power is provided to the second horn. When power is removed from the controller, R and C can reset and the controller is placed in an initial state.

When power is provided to the controller, the first horn can be actuated and provide the first tone. The controller can also determine the time that the switch is actuated and can include the volume of the first horn the longer the switch is actuated. The volume can be in a range so that the first horn does not exceed a predetermined volume. The controller can also determine the length of time (e.g., delay) and upon reaching the length of time, provide power to the second horn. Therefore, the operation can actuate the switch briefly and produce the tone from the first horn. Continue to actuate the switch for a length of time therefore providing power to the second horn. This allows the operator to determine the sound and volume produced from the horns by the way in which the switch is actuated. For example, a tap on a switch incorporated into the center of the steering wheel would result in a short, lower volume, higher pitched sound. Continuously pressing the center of the steering wheel would result in a longer, higher volume and high and low pitch sound.

The existing circuitry can include one or two horns. Some vehicles have a single horn that produces a basic, moderate-pitched sound. In this case, the present system allows for the addition of a second horn to provide the functionality of this system. Most vehicles, especially mid-range and higher-end models, have two horns tuned to different pitches. These two horns typically include a high tone and a low tone that when sounded together, create a fuller, more attention-grabbing sound, which is more effective at cutting through traffic noise. These horns sound together prior to the installation of this system. This system separate the operation of these two horns so that they are not sounding together, but as described herein.

In one embodiment the vehicle includes an original horn. The system can include an added horn that can be added to the vehicle horn circuitry. In one embodiment, the vehicle comes with two horns.

Referring to FIG. 1B, the controller can actuate a horn that includes a first tone 114 that is a sinusoidal waveform that can begin at T¹. The sinusoidal waveform can consist solely of the fundamental frequency of the waveform with no harmonics thereby resulting in a purer tone. When initially actuated, the horn would produce a tone that is lower in volume than other tones. After some period of time, such as at T² the controller can cause the horn to provide a second tone 116 that can be a square wave. This square waveform can be louder than the sinusoidal waveform given the same peak amplitude due to its harmonic content. A square wave contains not only the fundamental frequency (the base frequency) but also odd harmonics (3rd, 5th, 7th, etc.) at decreasing amplitudes. This harmonic content contributes to a fuller, more intense sound, making square waves appear louder. In one embodiment, embodiment, a first horn provides the sinusoidal waveform tone, and a second horn provides the squar3 waveform tone. In one embodiment, the first and second horn initially sound in series and at T³, the first and second horn can sound in parallel resulting in an even louder overall tone. In one embodiment the sinusoidal waveform can increase in amplitude resulting in an increased loudness from T¹ to T². When the waveform increases in amplitude, it generally gets louder. Amplitude represents the intensity of the sound wave, and an increase in amplitude means that the wave has a greater peak-to-peak displacement, which is perceived as an increase in loudness.

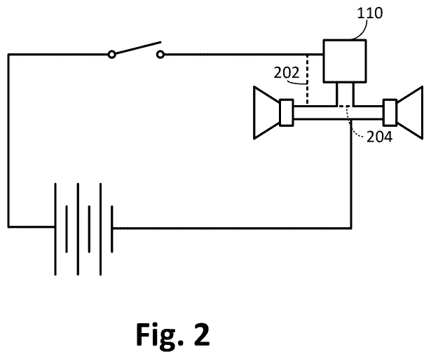

Referring to FIG. 2, controller 110 can be integrated into the existing circuitry by attaching one side of the power to the controller, the first horn to the controller and the second horn to the controller. The controller can then determine that the switch has been actuated and provide power to the first horn and the second horn. The existing circuits can include a first separation 202 where one side of the circuit is connected to the controller and the controller is connected to the first and second horn at a second separation 204.

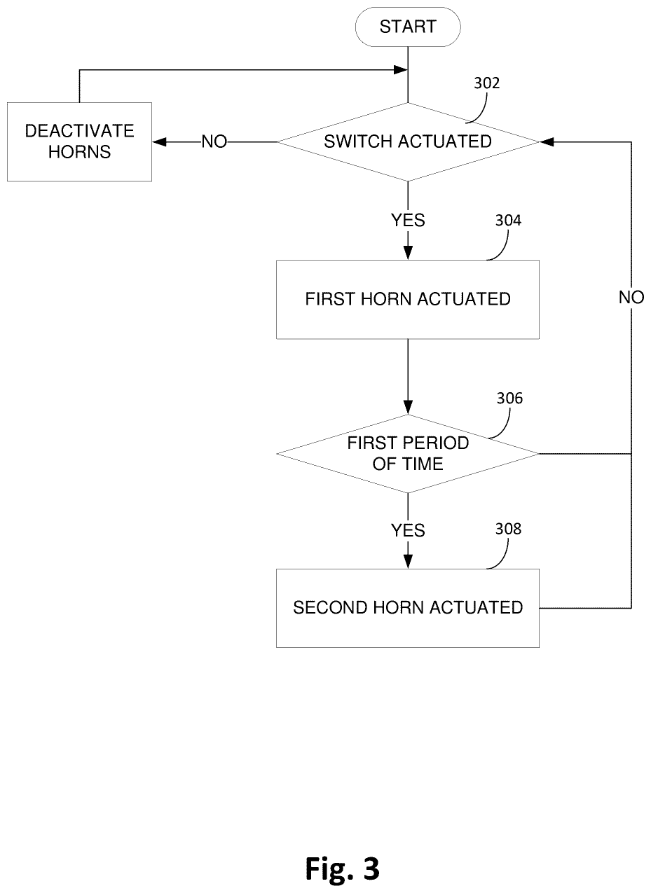

Referring to FIG. 3, the controller can include computer readable instructions that can include determining that the switch has been actuated at 302 such as by depressing a switch included in the center portion of steering wheel provided in most of all consumer and commercial vehicles. If the switch is actuated, the first horn can be actuated at 304. The first horn can be activated when the circuit is closed thereby providing power to the first horn or by the controller allowing power to be provided to the first horn. A determination can then be made at 306 whether a length of time has passed and if so, the second horn can be actuated at 308.

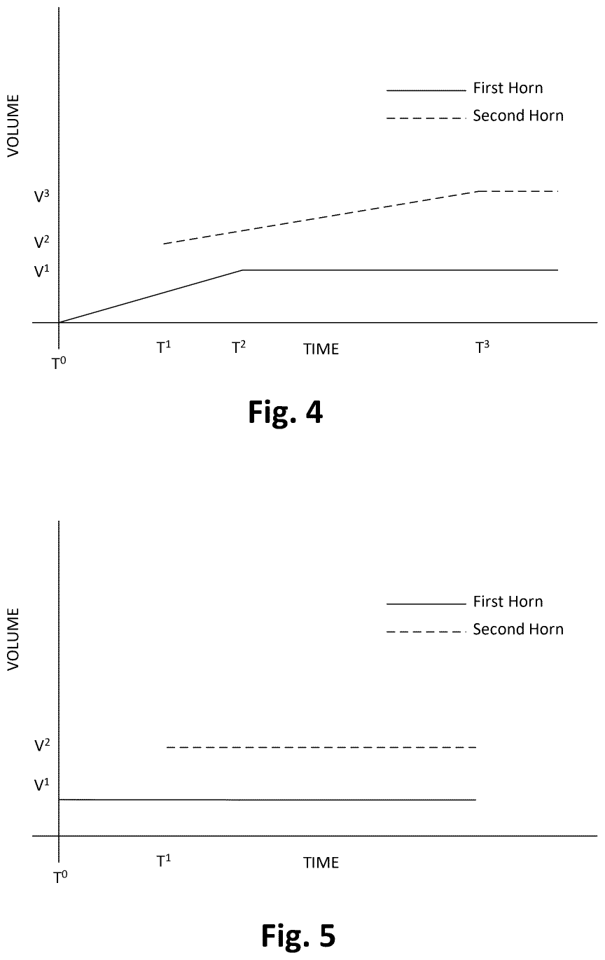

In one embodiment, the controller can also increase the volume of the first and second horn according to the length of time that the switch is actuated. Referring to FIG. 4, the actuation and volume of the horns is shown relative to the length of time that the switch is actuated. As shown, the second horn is actuated at T¹ and volume V² as the length of time increases, the volume increases until V³ is reached at T³ wherein the maximum volume of the second horn is reached. The first horn is actuated at T⁰ while the second horn is actuated at T¹. In one embodiment, the first horn gradually increases in volume with time and the second horn can begin at volume V². The first horn can also begin at a predetermined volume that is greater than zero. The first horn can reach a maximum volume V¹ and T².

In one embodiment the way the switch is actuated can determine the audio produced by the first and second horn. For example, when the controller determines a sequence of switch actuations, such as a quick tap, the controller can actuate the first horn for a short, low volume sound or for another combination such as a quick low or mid volume double sound (e.g., BEEP BEEP). When the controller determines a sequence of switch actuations, such as a quick double tap, the controller can actuate the first horn for a short, mid volume sound for a longer period. The switch actuation can be recognized by the controller can the first and second horn actuated in any number of combinations of length in time, sound, volume, and the like. The horns can be controlled by varying the power provided to the horns, the length of time the horn is actuated and the combination of the two. The harmony of the two horns can be used to vary the output of the horns.

The system can be integrated into an existing vehicle circuitry without the need for additional switches or controls in the cab or that need to be actuated by the operator.

In one embodiment, the controller can provide a reduced voltage for a quieter, more polite horn at an initial phase. After a period of time, the voltage can be increased up to 100% for one or more horns. The increase in the voltage can be time delayed. The controller can be implemented with an aftermarket component, integrated into the manufacturer controller or computer readable instructions, implemented with an application programming interface that can be included in the manufacture computer, controller of information system of the vehicle or any combination.

Referring to FIG. 5, the actuation and volume of the horns is shown relative to the length of time that the switch is actuated. As shown, the second horn is actuated at T¹ and volume V². This provides a louder horn since both horns are actuated at the same time. The first horn is actuated at T° while the second horn is actuated at T¹.

A system can be configured to perform particular operations or actions by virtue of having software, firmware, hardware, or a combination of them installed on the system that in operation causes or cause the system to perform the actions. A controller can be configured to perform operations or actions by virtue of including instructions that, when executed by a process, cause the apparatus to perform the actions. One general aspect includes a variable audio signaling device for a vehicle. The variable audio signaling device also includes a controller adapted to be integrated into an existing vehicle. The device can also include an original horn preexisting in the vehicle. The device can include an added horn adapted to be installed in the vehicle. The device can also include a switch, that when actuated, actuate the added horn, and. The device can include where the controller is adapted to receive a switch actuation, wait a predetermined period, and actuate the original horn. Other embodiments of this aspect include corresponding circuits, systems, and apparatus, each configured to perform the actions of the methods.

Implementations may include one or more of the following features. The system where the controller is adapted to increase a volume of the original horn after a length of time. The original horn produces a square waveform, and the second horn produces a sinusoidal waveform. The added horn includes a maximum volume. The volume of the added horn increases over time. The added horn is discontinued when the first horn is actuated. Implementations of the described techniques may include hardware, a method or process, or computer software on a computer-accessible medium.

One general aspect includes a variable audio signaling device for a vehicle. The variable audio signaling device also includes a first horn and a second horn included in an existing horn circuitry. The device also includes a controller adapted to be integrated into the existing horn circuitry. The device also includes a switch adapted to provide a switch actuation to the controller, and. The device also includes where the controller is adapted to receive the switch actuation, actuate the first horn, wait a predetermined period and actuate the second horn. Other embodiments of this aspect include corresponding computer systems, apparatus, and computer programs recorded on one or more computer storage devices, each configured to perform the actions of the methods.

Implementations may include one or more of the following features. The system where the controller is adapted to increase a volume of the first horn after a length of time. The controller is adapted to increase a volume of the second horn after a length of time. The controller is adapted to receive a sequence of switch actuations and actuate the first horn and the second horn in a combination according to the sequence of switch actuations. The first horn is discontinued when the second horn is actuated. The first horn is a sinusoid waveform with an increasing amplitude from a first time to a second time. Implementations of the described techniques may include hardware, a method or process, or computer software on a computer-accessible medium.

One general aspect includes a variable audio signaling device for a vehicle. The variable audio signaling device also includes an existing horn circuitry having a first horn and a second horn. The device also includes a controller integrated into the existing horn circuitry and adapted to isolate the second horn from the first horn. The device also includes where the controller is adapted to receive a switch actuation, wait a predetermined period, and actuate the second horn. Other embodiments of this aspect include corresponding computer systems, apparatus, and computer programs recorded on one or more computer storage devices, each configured to perform the actions of the methods.

Implementations may include one or more of the following features. The system where a volume of the first horn increases with time. A volume of the second horn increases with time. The first horn emits a sinusoidal waveform. The second horn emits a square waveform. The controller is adapted to discontinue the first horn upon actuation of the second horn. The controller is adapted to actuate the first horn upon receiving a first switch actuation pattern from the switch and actuate the second horn upon receiving a second switch actuation pattern from the switch. The first horn is an electric horn, and the controller is adapted to apply a voltage to the first horn that increases over time. Implementations of the described techniques may include hardware, a method or process, or computer software on a computer-accessible medium.

In one embodiment, the system described herein relate to a variable audio signaling device for a vehicle including: a controller adapted to be integrated into an existing vehicle; an original horn preexisting in the vehicle; an added horn adapted to be installed in the vehicle; a switch, that when actuated, actuate the added horn; and, wherein the controller is adapted to receive a switch actuation, wait a predetermined period, and actuate the original horn.

In one embodiment, the system described herein relate to a signaling device wherein the controller is adapted to increase a volume of the original horn after a length of time.

In one embodiment, the system described herein relate to a signaling device wherein the original horn produces a square waveform, and the added horn produces a sinusoidal waveform.

In one embodiment, the system described herein relate to a signaling device wherein the added horn includes a maximum volume.

In one embodiment, the system described herein relate to a signaling device wherein a volume of the added horn increases over time.

In one embodiment, the system described herein relate to a signaling device wherein the added horn is discontinued when the original horn is actuated.

In one embodiment, the system described herein relate to a variable audio signaling device for a vehicle including: a first horn and a second horn included in an existing horn circuitry; a controller adapted to be integrated into the existing horn circuitry; a switch adapted to provide a switch actuation to the controller; and, wherein the controller is adapted to receive the switch actuation, actuate the first horn, wait a predetermined period and actuate the second horn.

In one embodiment, the system described herein relate to a signaling device wherein the controller is adapted to increase a volume of the first horn after a length of time.

In one embodiment, the system described herein relate to a signaling device wherein the controller is adapted to increase a volume of the second horn after a length of time.

In one embodiment, the system described herein relate to a signaling device wherein the controller is adapted to receive a sequence of switch actuations and actuate the first horn and the second horn in a combination according to the sequence of switch actuations.

In one embodiment, the system described herein relate to a signaling device wherein the first horn is discontinued when the second horn is actuated.

In one embodiment, the system described herein relate to a signaling device wherein the first horn is a sinusoid waveform with an increasing amplitude from a first time to a second time.

In one embodiment, the system described herein relate to a variable audio signaling device for a vehicle including: an existing horn circuitry having a first horn and a second horn; a controller integrated into the existing horn circuitry and adapted to isolate the second horn from the first horn; wherein the controller is adapted to receive a switch actuation, wait a predetermined period, and actuate the second horn.

In one embodiment, the system described herein relate to a signaling device wherein a volume of the first horn increases with time.

In one embodiment, the system described herein relate to a signaling device wherein a volume of the second horn increases with time.

In one embodiment, the system described herein relate to a signaling device wherein the first horn emits a sinusoidal waveform.

In one embodiment, the system described herein relate to a signaling device wherein the second horn emits a square waveform.

In one embodiment, the system described herein relate to a signaling device wherein the controller is adapted to discontinue the first horn upon actuation of the second horn.

In one embodiment, the system described herein relate to a signaling device including: a switch included in the existing horn circuitry; and, wherein the controller is adapted to actuate the first horn upon receiving a first switch actuation pattern from the switch and actuate the second horn upon receiving a second switch actuation pattern from the switch.

In one embodiment, the system described herein relate to a signaling device wherein the first horn is an electric horn, and the controller is adapted to apply a voltage to the first horn that increases over time.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A variable audio signaling device for a vehicle comprising:
a controller adapted to be integrated into an existing vehicle;
an original horn preexisting in the vehicle;
an added horn adapted to be installed in the vehicle;
a switch, that when actuated, actuate the added horn; and,
wherein the controller is adapted to receive a switch actuation, wait a predetermined period, and actuate the original horn.

2. The signaling device of claim 1 wherein the controller is adapted to increase a volume of the original horn after a length of time.

3. The signaling device of claim 1 wherein the original horn produces a square waveform, and the added horn produces a sinusoidal waveform.

4. The signaling device of claim 1 wherein the added horn includes a maximum volume.

5. The signaling device of claim 1 wherein a volume of the added horn increases over time.

6. The signaling device of claim 1 wherein the added horn is discontinued when the original horn is actuated.

7. A variable audio signaling device for a vehicle comprising:
a first horn and a second horn included in an existing horn circuitry;
a controller adapted to be integrated into the existing horn circuitry;
a switch adapted to provide a switch actuation to the controller; and,
wherein the controller is adapted to receive the switch actuation, actuate the first horn, wait a predetermined period and actuate the second horn.

8. The signaling device of claim 7 wherein the controller is adapted to increase a volume of the first horn after a length of time.

9. The signaling device of claim 7 wherein the controller is adapted to increase a volume of the second horn after a length of time.

10. The signaling device of claim 7 wherein the controller is adapted to receive a sequence of switch actuations and actuate the first horn and the second horn in a combination according to the sequence of switch actuations.

11. The signaling device of claim 7 wherein the first horn is discontinued when the second horn is actuated.

12. The signaling device of claim 7 wherein the first horn is a sinusoid waveform with an increasing amplitude from a first time to a second time.

13. A variable audio signaling device for a vehicle comprising:
an existing horn circuitry having a first horn and a second horn;
a controller integrated into the existing horn circuitry and adapted to isolate the second horn from the first horn;
wherein the controller is adapted to receive a switch actuation, wait a predetermined period, and actuate the second horn.

14. The signaling device of claim 13 wherein a volume of the first horn increases with time.

15. The signaling device of claim 13 wherein a volume of the second horn increases with time.

16. The signaling device of claim 13 wherein the first horn emits a sinusoidal waveform.

17. The signaling device of claim 13 wherein the second horn emits a square waveform.

18. The signaling device of claim 13 wherein the controller is adapted to discontinue the first horn upon actuation of the second horn.

19. The signaling device of claim 18 including:
a switch included in the existing horn circuitry; and,
wherein the controller is adapted to actuate the first horn upon receiving a first switch actuation pattern from the switch and actuate the second horn upon receiving a second switch actuation pattern from the switch.

20. The signaling device of claim 13 wherein the first horn is an electric horn, and the controller is adapted to apply a voltage to the first horn that increases over time.
